(19) United States
(12) Patent Application Publication
(10) Pub. No.: US 2010/0179866 A1
(43) Pub. Date: Jul. 15, 2010

(54) Location-multimedia-based signature system

(76) Inventors: Jack Su, (US); Wenbin Lin, (US)

Correspondence Address: Jack Su, 208 Oak Harbor Ln, Cary, NC, 27519, US

(21) Appl. No.: 12/587,094

(22) Filed: Oct. 2, 2009

Related U.S. Application Data
(60) Provisional application No. 61/203,917, filed on Dec. 31, 2008.

(51) Int. Cl. G06Q 30/00

(52) U.S. Cl. 705/14.4

(57) ABSTRACT

A system uses multimedia data, such as photo of part or whole receipt, records of payment process, and/or signature inputted directly on the touch-phone, as the proof of offline transaction. The multimedia data are uploaded with tags to a center server via internet or wireless network. This system could prove that costumer has finished a transaction such as purchase, which could be a key element for the offline Cost-Per-Action (CPA) advertisement mode, reservation and/or incentive system. This multimedia signature could also be used in authorizing consumers to perform buyer reviews.

The mobile devices, which can support multimedia input and output, internet access, location-awareness, and/or touch screen, such as iPhone and gPhone, could be employed for this system.

### FIELD OF THE INVENTION

Mobile Device; Computer; Internet; Wireless Network; Offline Transaction Proof; Cost-Per-Action Advertisement; Review System; Incentive System.

More specifically, this invention relates to a method for recording, storing, and supplying offline transaction proofs by using a mobile device, wireless network or internet, and a center server.

### BACKGROUND OF THE INVENTION

Cost-Per-Action (CPA) mode is an optimal way for advertisers, since they don't need to pay any advertisement cost except that the advertisement has directly leaded an effective transaction such as purchase. However, there has been no effective method to track the offline transactions in the frame of Cost-Per-Action mode so far.

The same situation also applies to the online review and/or incentive system about the offline transactions. Online reviews and recommendations have become more and more important factors for customers to choose the best product or service, but the reliability of reviews is under concern because the customers do not know if the reviewers finished the corresponding transactions. For example, maybe these reviews are just the “advertisements” made by the business owners. Meanwhile, the online incentive system cannot work well for the offline transactions either.

The objective of our invention is to provide an easy, low cost, and traceable system for recording offline transactions, which can integrate the offline transactions into the CPA mode, and supply the transaction proof for the online review and/or incentive system.

### SUMMARY OF THE INVENTION

This signature system uses mobile devices, which can support multimedia input and output, location-awareness and/or touch screen, to obtain multimedia data and then uploaded them with tags to a center server via internet or wireless network. The multimedia data include photo of part or whole receipt, audio or video of payment process, manual signature inputted on the touch screen. The location-multimedia-based signature system is a key element for the Cost-Per-Action (CPA) advertisement mode and the review and/or incentive system, because it can be used as proof for offline transactions in offline CPA mode for the commission fee, or in authorizing costumer to perform a buyer review.

### BRIEF DESCRIPTION OF THE DRAWINGS

FIG. 1 shows system architecture.

FIG. 2 presents the database schema for the center server.

FIG. 3 is a main flow chart illustrating a CPA advertisement application, combined with a review and incentive system.

### DETAILED DESCRIPTION OF THE INVENTION

Hereinafter we will describe the invention more fully with reference to the accompanying drawings, in which some applications of the invention are also presented.

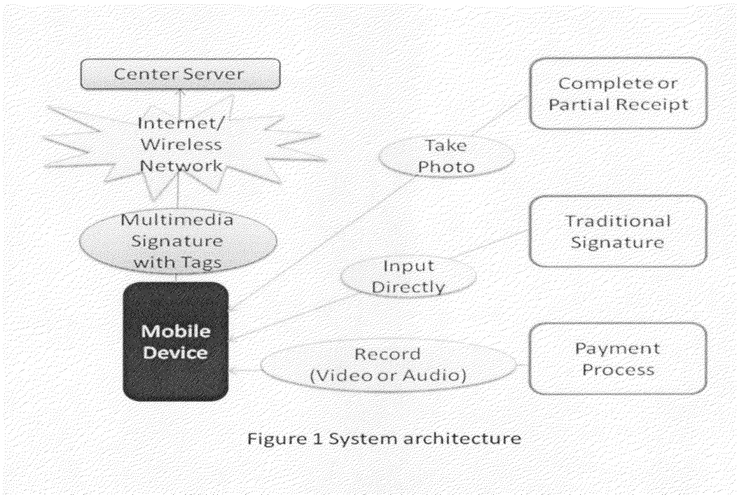

During the end of an offline transaction, the customer could use the location-multimedia-internet-ready mobile device, such as iPhone, gPhone, blackberry and so on, to take a photo of partial or complete receipt, or record the payment process with video or audio, or save the traditional signature inputted by a business clerk on the touch screen of the mobile device. These multimedia data are defined as the multimedia signature, which along with some tags will be sent to a center database via internet or wireless network by the mobile device. The tags may include one or more items in the following: consumer's user ID (at the center server), name, phone number, device number, date and time, and the location information provided by the mobile device. The uploaded data can be regarded as a proof for the offline transaction, and will be used for future reference in the offline Cost-Per-Action (CPA) advertisement mode, the online review and/or incentive system. The system architecture for this invention is illustrated in FIG. 1.

The database at the center sever stores the following information:
Business information, which may include business owner's user ID, business ID, incentive ID, business name, address, phone number, description of business (text, photo, video), category/subcategory and website link and so on. The business owner can log into the server with business user ID and password to upload the detailed business information.
Customer information, which may include customer's user ID, mobile device ID, phone number, email address and so on.
The multimedia signatures with the corresponding tags
Cost-Per-Action application and/or review and/or incentive system

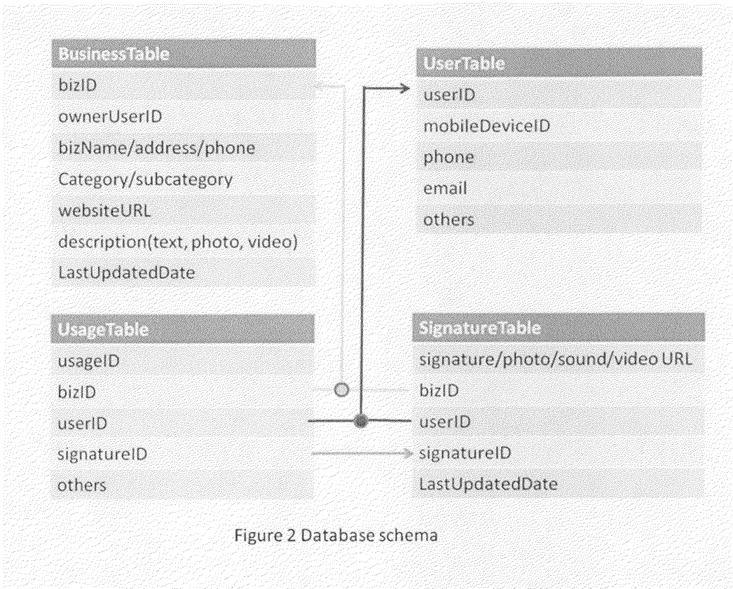

The database schema for the center server is presented in FIG. 2. Here the server can have more than one usage table: Cost-Per-Action application, reservation system, review system, and incentive system, and so on.

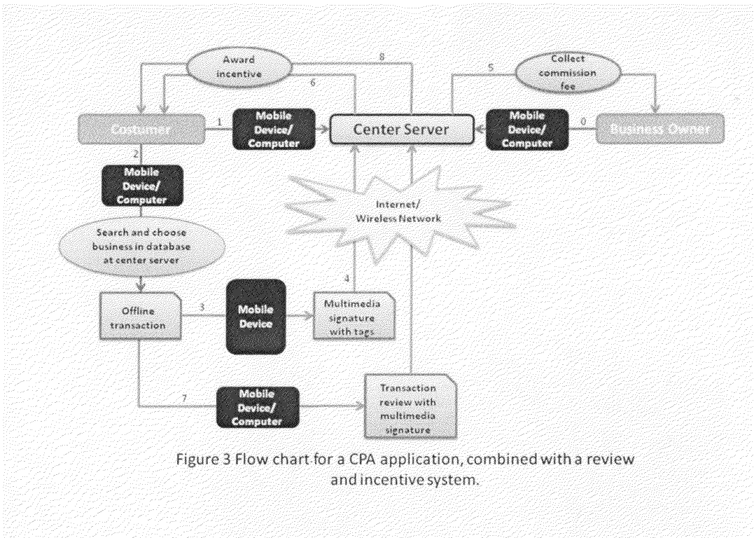

The exemplifying method is demonstrated in a CPA advertisement application, combined with a review and incentive system. The main flow chart is shown in FIG. 3, and each step (denoted by the number in red) is described in detail in the following:
Step 0: Business owners are not required to register to the review system, though the system provides the business' information and customer's reviews on their service. However, if the business owners want to take part in the CPA advertisement system, for example, to provide detailed business and incentive information, they need to setup an account on the center server via an internet-ready computer or mobile device, and deposit some funds to an escrow account for the commission fee, which will be collected only when the corresponding offline transaction is finished (see the step 5 below).
Step 1: Costumers can use an internet-ready computer or mobile device to register at the center server.
Step 2: Costumers can use a location-aware mobile device, such as iPhone, or just web browser, to search and choose local business service basing on the business profile, reviews and incentive information provided by the database at the center server.
Step 3: At the end of offline transaction, the costumer can present the electronic incentive information (shown with incentive ID on the mobile device) during payment process to get discount. The costumer can use the mobile device to take a photo of part or whole receipt, or to record the payment process with audio or video, or to save the clerk's signature inputted on the touch screen. All these data are called as multimedia signature.
Step 4: The multimedia signature with some tags, such as business ID, incentive ID, consumer's user ID, name, phone number, device number, date and time, and the location information, will be sent to the center server by the mobile device.
Step 5: Once the system receives the multimedia signature with the corresponding tags, it will collect the corresponding commission fee from the business owner's escrow account.
Step 6: The system will award some incentive to the costumer.
Step 7: The costumer may perform an onsite multimedia review, and send this review along with the above multimedia signature and tags to the center server by the mobile device. The costumers can also input their reviews via a computer.
Step 8: Once the system receives the review, it will award some incentive to the costumer.

Notice that the entire CPA advertisement application with the incentive system involves the step 0, 1, 2, 3, 4, 5 and the step 6.

It is to be understood that the specific examples in the foregoing descriptions and associated drawings are just an illustration for potential applications of this invention, therefore, this invention is no to be limited to the examples disclosed above.

1. A method for recording, storing, and providing proof for offline transactions, the method comprising the steps of: using a mobile device to take a photo of a transaction receipt, or to record the payment process with audio or video, or to save the signature inputted by the clerk on the touch screen (of the mobile device), using the mobile device to send these multimedia data (photo, audio, video, signature) with tags to a center server for future reference, which could be used in, but not limited in the fields of the Cost-Per-Action advertisement applications, the review and/or incentive system.
